(19) United States
(12) Patent Application Publication
(10) Pub. No.: US 2025/0218386 A1
(43) Pub. Date: Jul. 3, 2025

(54) PIXEL CIRCUIT AND DISPLAY DEVICE INCLUDING THE SAME

(71) Applicant: LG Display Co., Ltd., Seoul (KR)

(72) Inventors: Ye Lim KIL, Paju-si (KR); Dong Gun LEE, Paju-si (KR)

(73) Assignee: LG Display Co., Ltd., Seoul (KR)

(21) Appl. No.: 18/962,589

(22) Filed: Nov. 27, 2024

(30) Foreign Application Priority Data
Dec. 28, 2023 (KR) 10-2023-0193956

(51) Int. Cl. G09G 3/3258; G09G 3/3266; G09G 3/3291

(52) U.S. Cl. CPC G09G 3/3258; G09G 3/3266; G09G 3/3291; G09G 2310/08; G09G 2320/0233; G09G 2320/028

(57) ABSTRACT

A pixel circuit and a display device including the same are discussed. The pixel circuit can include a first light emitting element, a second light emitting element, a driving element configured to drive the first and second light emitting elements, a compensation circuit connected to the driving element, a first switch element connected between the driving element and the first light emitting element and driven by a first mode selection signal, a second switch element connected between the driving element and the second light emitting element and driven by a second mode selection signal, and a third switch element configured to apply a predetermined compensation voltage to at least one of anode electrodes of the first light emitting element and the second light emitting element.

### CROSS-REFERENCE TO RELATED APPLICATION

This application claims priority to Korean Patent Application No. 10-2023-0193956, filed Dec. 28, 2023, the entire contents of which is hereby expressly incorporated by reference into the present application.

### BACKGROUND

### 1. Field

The present disclosure relates to a pixel circuit and a display device including the same.

### 2. Discussion of the Related Art

Variable viewing angle technology is being applied to display devices. Variable viewing angle technology can present video content or visual information reproduced on a display device only to a user within a narrow viewing angle range, or to multiple users within a wide viewing angle range.

As the market for future vehicles such as electric vehicles and self-driving cars expands, demand for vehicle display devices is rapidly increasing. Research is being conducted on a method of dividing the screen of a vehicle display device and controlling one part of the screen to have a narrow viewing angle and the other part to have a wide viewing angle. This technology can drive pixels with a narrow viewing angle arranged in one area of the screen to display personal contents or information that only a specific user can view, and simultaneously drive pixels with a wide viewing angle arranged in the other area of the screen to display shared contents that multiple users can view together.

In vehicle display devices, display panels for organic light emitting display devices are attracting attention. An organic light emitting display device includes an organic light emitting diode (hereinafter, referred to as “OLED”) that emits light by itself, and has an advantage in that the response speed is fast, the luminous efficiency and luminance are good, and the viewing angle is wide. The organic light emitting display device has a fast response speed, is excellent in terms of luminous efficiency, luminance and viewing angle, and provides an excellent contrast ratio and color reproducibility since it can express the black grayscale in complete black. Because the display panel of an organic light emitting display device can be flexibly bent, it can easily implement a curved surface. Due to these advantages, the share of organic light emitting display devices in the vehicle display device market is rapidly increasing.

### SUMMARY OF THE DISCLOSURE

Due to a deviation in the panel fabrication process, a difference in the capacitance of parasitic capacitors formed in the light emitting elements can occur at each in-plane position. This can result in a difference in charging time between the anode voltage of the first light emitting element and the anode voltage of the second light emitting element in a low grayscale with a small amount of current, leading to a deviation in luminance uniformity in a low grayscale.

The present disclosure is directed to solving or address all the above-described necessities and limitations associated with the related art.

The present disclosure provides a pixel circuit and a display device including the same.

It should be noted that objects of the present disclosure are not limited to the above-described objects, and other objects of the present disclosure will be apparent to those skilled in the art from the following descriptions.

A pixel circuit according to embodiments of the present disclosure can include a first light emitting element; a second light emitting element; a driving element configured to drive the first and second light emitting elements; a compensation circuit connected to the driving element; a first switch element connected between the driving element and the first light emitting element and driven by a first mode selection signal; a second switch element connected between the driving element and the second light emitting element and driven by a second mode selection signal; and a third switch element configured to apply a predetermined compensation voltage to at least one of anode electrodes of the first light emitting element and the second light emitting element.

A display device according to embodiments of the present disclosure can include a pixel array in which a plurality of data lines, a plurality of gate lines, and a plurality of pixel circuits are disposed; a data driver configured to output a data voltage to the plurality of data lines; and a gate driver configured to output a gate signal to the plurality of gate lines, wherein each of the pixel circuits includes a first light emitting element; a second light emitting element; a driving element configured to drive the first and second light emitting elements; a compensation circuit connected to the driving element; a first switch element connected between the driving element and the first light emitting element and driven by a first mode selection signal; a second switch element connected between the driving element and the second light emitting element and driven by a second mode selection signal; and a third switch element configured to apply a predetermined compensation voltage to at least one of anode electrodes of the first light emitting element and the second light emitting element.

According to one or more aspects of the present disclosure, by initializing the anode electrode of the light emitting element to a reference voltage and then applying a compensation voltage of a predetermined voltage level before the emission period, the initial voltage of the anode electrode can be increased, thereby compensating for a luminance deviation in a low grayscale region with a small amount of current.

According to one or more aspects of the present disclosure, low power driving can be possible by compensating for a luminance deviation in a low grayscale region.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIG. 2 is a circuit diagram illustrating a pixel circuit according to an embodiment of the present disclosure;

FIG. 3 is a diagram illustrating an example of lenses disposed on first and second light emitting elements shown in FIG. 2;

FIG. 4 is a diagram illustrating waveforms for driving the pixel circuit shown in FIG. 2 in a first mode;

FIGS. 5A to 5F are diagrams illustrating an operation of a pixel circuit in a first mode driving;

FIG. 6 is a diagram illustrating different waveforms for driving the pixel circuit shown in FIG. 2 in a first mode;

FIGS. 7A and 7B are diagrams comparing luminance deviations between a comparative example and an embodiment of the present disclosure;

FIG. 8 is a diagram illustrating waveforms for driving the pixel circuit shown in FIG. 2 in a second mode;

FIGS. 9A to 9F are diagrams illustrating an operation of a pixel circuit in a second mode driving;

FIG. 10 is a diagram illustrating different waveforms for driving the pixel circuit shown in FIG. 2 in a second mode;

FIG. 11 is a diagram illustrating waveforms for simultaneously driving the pixel circuit shown in FIG. 2 in first and second modes; and

FIGS. 12A to 12E are diagrams illustrating an operation of the pixel circuit by the waveforms of FIG. 11.

### DETAILED DESCRIPTION OF THE EMBODIMENTS

Advantages and features of the present disclosure and methods of achieving them will become apparent with reference to preferable embodiments, which are described in detail, in conjunction with the accompanying drawings. However, the present disclosure is not limited to the embodiments to be described below and can be implemented in different forms, the embodiments are only provided to completely disclose the present disclosure and completely convey the scope of the present disclosure to those skilled in the art, and the present disclosure is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the disclosure. Further, in describing the present disclosure, when it is determined that a detailed description of related known technology can unnecessarily obscure the gist of the present disclosure, the detailed description thereof will be omitted.

When ‘including,’ ‘having,’ ‘consisting,’ and the like mentioned in the present disclosure are used, other parts can be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts can be located between the two parts unless ‘immediately’ or ‘directly’ is used.

Although first, second, and the like are used to describe various components, these components are not limited by these terms and may not define any order or sequence. These terms are only used to distinguish one component from another. Accordingly, a first component, which is mentioned, below can also be a second component within the technical spirit of the present disclosure.

The same reference numerals can refer to substantially the same elements throughout the present disclosure.

The following embodiments can be partially or entirely bonded to or combined with each other and can be linked and operated in technically various ways. The embodiments can be carried out independently of or in association with each other. Further, the term “can” encompasses all the meanings and coverages of the term “may.”

Hereinafter, various embodiments of the present disclosure will be described in detail with reference to the accompanying drawings. All the components of each display device or apparatus according to all embodiments of the present disclosure are operatively coupled and configured.

In a display device of the present disclosure, the pixel circuit and the gate driving circuit can include a plurality of transistors. Transistors can be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor (p-channel metal-oxide semiconductor (PMOS), since carriers are holes, a source voltage is higher than a drain voltage such that holes can flow from a source to a drain. In the p-channel transistor, since holes flow from the source to the drain, a current flows from the source to the drain. It should be noted that a source and a drain of a transistor are not fixed. For example, a source and a drain can be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage can be a gate high voltage, and a gate-off voltage can be a gate low voltage. In the case of the p-channel transistor, a gate-on voltage can be a gate low voltage, and a gate-off voltage can be a gate high voltage.

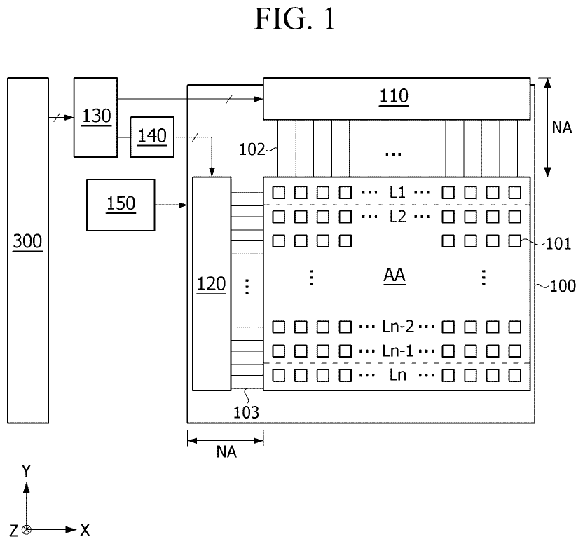

FIG. 1 is a block diagram illustrating a display device according to one embodiment of the present disclosure.

Referring to FIG. 1, the display device according to the one embodiment of the present disclosure includes a display panel 100, and a display panel driving circuit for writing pixel data to pixels of the display panel 100. Additionally, the display device includes a power supply 150. The display panel 100 includes a display area (or active area) AA and a non-display area (or non-active area) NA surrounding the display area AA entirely or in part.

The display panel 100 can be, but is not limited to, a panel having a rectangular structure with a length in an X-axis direction, a width in a Y-axis direction, and a thickness in a Z-axis direction. For example, the display panel 100 can be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 can further include power lines commonly connected to the pixels. The power lines can be commonly connected to pixel circuits to supply a voltage required for driving pixels 101 to the pixels 101.

Each of the pixels 101 can be divided into a red sub-pixel, a green sub-pixel, and a blue sub-pixel for color implementation. Each pixel can further include a white sub-pixel. Each sub-pixel includes a pixel circuit for driving a light emitting element. The light emitting element can include an OLED (organic light emitting diode or the like) or an inorganic light emitting diode (LED). Each pixel circuit is connected to the data lines, the gate lines, and the power lines. In the following description, a pixel can be interpreted as a sub-pixel.

The pixels can be arranged as real color pixels and pentile pixels. A pentile pixel can realize a higher resolution than a real color pixel by driving two sub-pixels with different colors as one pixel 101 and using a preset pixel rendering algorithm. This pixel rendering algorithm can compensate for insufficient color representation in each pixel with the color of light emitted from adjacent pixels.

Each of the pixels can include at least one first light-emitting element that emits light in first mode, and a second light-emitting element that emits light in second mode. Each of the pixels 101 emits light from the first light-emitting element at a wide viewing angle in first mode, while emitting light from the second light-emitting element at a narrow viewing angle in second mode.

The display area AA includes a plurality of pixel lines L1 to Ln, where n can be a real number such as an integer greater than 1. Each of the pixel lines L1 to Ln includes one line of pixels arranged along the line direction (e.g., X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 can be implemented with a non-transmissive display panel or a transmissive display panel. The transmissive display panel can be applied to a transparent display device in which an image is displayed on the screen and a real object in the background is visible. The display panel 100 can be made of a flexible display panel.

The power supply 150 receives an input voltage applied from the host system 200 and outputs a voltage needed to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage can be supplied to the level shifter 140 and the gate driver 120. Voltages such as pixel driving voltage, cathode voltage, and reference voltage can be supplied to the pixels 101 through the power lines commonly connected to the pixels 101.

The power supply 150 can further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator can be implemented with a programmable gamma circuit that can adjust the voltage of each of the gamma reference voltages according to digital data. The timing controller 130, the host system 200, or a separate external device can update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit can further include a touch sensor driver for driving touch sensors. The data driver 110 and the touch sensor driver can be integrated into one source drive integrated circuit (IC).

The data driver 110 receives pixel data of the input image as a digital signal from the timing controller 130 and outputs a data voltage. The data driver 110 can receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data can include mode selection data for selecting first mode and second mode. The DAC converts the pixel data into a gamma compensation voltage and outputs a data voltage of the pixel data.

The gate driver 120 can be formed on the display panel 100 together with the circuit elements and wiring lines of the display area AA. The gate driver 120 can be disposed in at least one of left and right non-display areas NA outside the display area AA in the display panel 100 or at least a part thereof can be disposed within the display area AA.

The gate driver 120 can be disposed in the non-display areas NA on both sides of the display panel 100 with the display area AA of the display panel interposed therebetween to supply gate pulses on both sides of the gate lines 103 in a double feeding method. In another embodiment, the gate driver 120 can be disposed in at least one of the left and right non-display areas NA of the display panel 100 to supply gate signals to the gate lines 103 in a single feeding method. The gate driver 120 sequentially outputs pulses of the gate signals to the gate lines 103 under the control of the timing controller 130. The gate driver 120 can sequentially supply the gate signals to the gate lines 103 by shifting the pulses of the gate signals using shift registers. When a plurality of gate signals are applied to each pixel, the gate driver 120 can include a plurality of shift registers. The gate signal can include a scan signal being input to the pixel circuit through a plurality of gate lines, and an emission signal (or EM signal).

The timing controller 130 receives digital video data of an input image and a timing signal synchronized with this data from the host system 200. The timing signal can include a vertical synchronization signal Vsync, a horizontal synchronization signal Hsync, and a data enable signal DE. Since the vertical period and horizontal period can be known by counting the data enable signal DE, the vertical synchronization signal Vsync and the horizontal synchronization signal Hsync can be omitted. The horizontal synchronization signal Hsync and the data enable signal DE have a periodicity of 1 horizontal period (1H).

The timing controller 130 can control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 can synchronize the data driver 110 and the gate driver 120 by controlling the operation timing of the display panel driving circuit.

The gate timing control signal output from the timing controller 130 can be input to the shift register of the gate driver 120 through the level shifter 140. The level shifter 140 can convert a voltage of the gate timing control signal received from the timing controller 130 to a swing width between the gate-on voltage and the gate-off voltage and supply it to the gate driver 120.

The timing controller 130 can supply first and second mode selection signals S_sel and P_sel to a pixel circuit. For example, the timing controller 130 can generate the first and second mode selection signals S_sel and P_sel of a first voltage level and supply them to a level shifter, and the level shifter can convert the first and second mode selection signals S_sel and P_sel of the first voltage level into the first and second mode selection signals S_sel and P_sel of a second voltage level and supply them to the pixel circuit.

The host system 200 can include a main board of one of a television system, a set-top box, a navigation system, a personal computer (PC), a vehicle system, a mobile terminal, and a wearable terminal. The host system 200 can scale an image signal from a video source according to the resolution of the display panel 100, and can transmit it to the timing controller 130 together with the timing signals.

The host system 200 can transmit a mode signal having different logic values in first mode and second mode together with an image signal to the timing controller 130 at least once per frame.

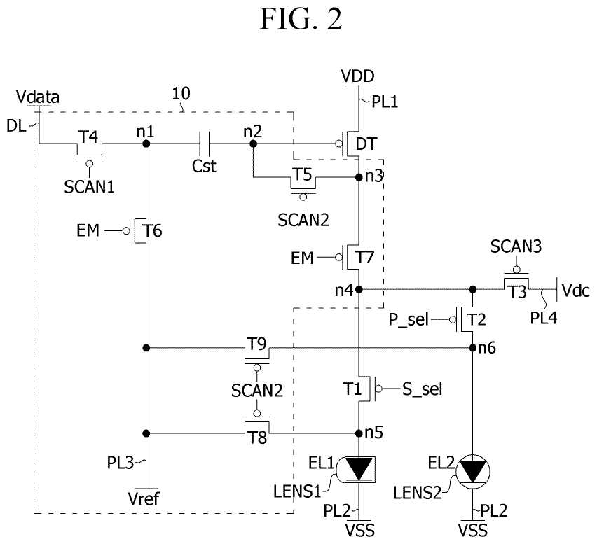

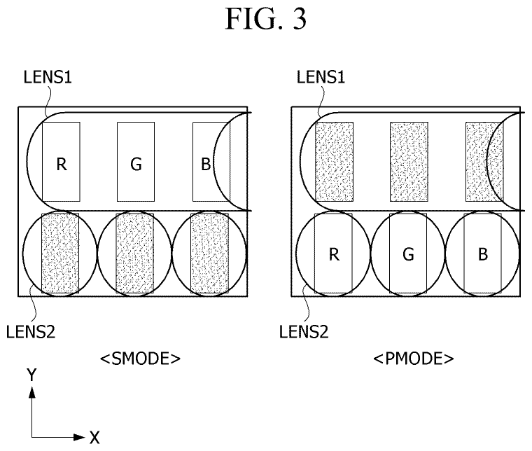

FIG. 2 is a circuit diagram illustrating a pixel circuit according to an embodiment of the present disclosure. FIG. 3 is a diagram illustrating lenses disposed on the first and second light emitting elements shown in FIG. 2. Each pixel circuit of FIG. 1 can have the configuration of the pixel circuit of FIG. 2.

Referring to FIGS. 2 and 3, the pixel circuit according to an embodiment includes a first light emitting element EL1 that emits light in a first mode SMODE, a second light emitting element EL2 that emits light in a second mode PMODE, a driving element DT that drives the first and second light emitting elements EL1 and EL2, a compensation circuit 10 connected to the driving element, a first switch element T1, a second switch element T2, and a third switch element T3. The compensation circuit includes a plurality of switch elements T4 to T9 and a capacitor Cst. The driving element DT and the switch elements T1 to T9 can be implemented as p-channel transistors, but are not limited thereto.

The pixel circuit is connected to power lines through which DC voltages or constant voltages are applied, such as a pixel driving voltage line (or a first power line) PL1 for applying a pixel driving voltage VDD, a pixel base voltage line (or a second power line) PL2 for applying a pixel base voltage VSS, a reference voltage line (or a third power line) PL3 for applying a reference voltage Vref, and a compensation voltage line (or a fourth power line) PL4 for applying a compensation voltage Vdc. The power lines on the display panel 100 can be connected in common to all pixels.

The pixel driving voltage VDD is set to a voltage higher than the maximum voltage of the data voltage Vdata and allows the driving element DT to operate in a saturation region. The pixel driving voltage VDD is a voltage higher than the pixel base voltage VSS. The reference voltage Vref can be set to a voltage that is lower than the pixel driving voltage VDD and higher than the pixel base voltage VSS. A gate-on voltage VGL can be set to a voltage higher than the pixel driving voltage VDD and a gate-off voltage VGH can be set to a voltage lower than the pixel base voltage VSS.

The driving element DT drives the first and second light-emitting elements EL1 and EL2 by generating a current according to a gate-source voltage Vgs. The driving element DT includes a first electrode connected to the first power line PL1 to which the pixel driving voltage VDD is applied, a gate electrode connected to a second node n2, and a second electrode connected to a third node n3.

The first and second light-emitting elements EL1 and EL2 can be implemented as organic light-emitting diodes (OLEDs). Each of the light-emitting elements EL1 and EL2 includes an anode, a cathode, and an organic compound layer formed between the anode and the cathode. The anode of the first light-emitting element EL1 is connected to a fifth node n5, and the cathode thereof is connected to the second power line PL2 to which the pixel base voltage VSS is applied. The anode of the second light-emitting element EL2 is connected to a sixth node n6, and the cathode thereof is connected to the second power line PL2. The organic compound layer can include a hole injection layer HIL, a hole transport layer HTL, an emission layer EML, an electron transport layer ETL, and an electron injection layer EIL, but the present disclosure is not limited thereto. Each of the light-emitting elements EL1 and EL2 can be implemented in a tandem structure in which a plurality of light-emitting layers are stacked. The light-emitting elements EL1 and EL2 of the tandem structure can improve the luminance and lifetime of the pixel.

The first switch element T1 is connected between a fourth node n4 and a fifth node n5. The first switch element T1 is turned on in response to a gate-on voltage VGL of the first mode selection signal S_sel to connect the fourth node n4 to the fifth node n5. The first switch element T1 includes a first electrode connected to the fourth node n4, a gate electrode to which the first mode selection signal S_sel is applied, and a second electrode connected to the fifth node n5.

The second switching element T2 is connected between the fourth node n4 and a sixth node n6. The second switching element T2 is turned on in response to the gate-on voltage VGL of the second mode selection signal P_sel to connect the fourth node n4 to the sixth node n6. The second switch element T2 includes a first electrode connected to the fourth node n4, a gate electrode to which the second mode selection signal P_sel is applied, and a second electrode connected to the sixth node n6.

The third switch element T3 is connected between the fourth node n4 and the fourth power line PL4. The third switch element T3 is turned on in response to the gate-on voltage VGL of a third gate signal SCAN3 to connect the fourth node n4 to the fourth power line PL4 through which the compensation voltage Vdc is applied. The third switch element T3 includes a first electrode connected to the fourth node n4, a gate electrode to which the third gate signal SCAN3 is applied, and a second electrode connected to the fourth power line PL4.

The compensation circuit 10 can initialize the pixel circuit and compensate a data voltage Vdata inputted through a data line DL by a threshold voltage Vth of the driving element DT.

The capacitor Cst is connected between a first node n1 and a second node n2. During a sensing period Tsen, the data voltage Vdata that has been compensated by the threshold voltage Vth of the driving element DT is stored in the capacitor Cst. The capacitor Cst maintains a gate-source voltage Vgs of the driving element DT during an emission period Tem.

The fourth switch element T4 is connected between the data line DL and the first node n1. The fourth switch element T4 is turned on in response to the gate-on voltage VGL of a first gate signal SCAN1 to apply the data voltage Vdata of pixel data to the capacitor Cst. The fourth switch element T4 includes a first electrode connected to the data line DL, a gate electrode to which the first gate signal SCAN1 is applied, and a second electrode connected to the first node n1.

The fifth switch element T5 is connected between the second node n2 and a third node n3. The fifth switch element T5 is turned on in response to the gate-on voltage VGL of a second gate signal SCAN2 to connect the gate electrode of the driving element DT to the second electrode thereof. The fifth switch element T5 includes a first electrode connected to the second node n2, a gate electrode to which the second gate signal SCAN2 is applied, and a second electrode connected to the third node n3.

The sixth switch element T6 is connected between the first node n1 and the third power line PL3. The sixth switch element T6 is turned on in response to the gate-on voltage VGL of a fourth gate signal EM to connect the first node n1 to the third power line PL3. The sixth switch element T6 includes a first electrode connected to the first node n1, a gate electrode to which the fourth gate signal EM is applied, and a second electrode connected to the third power line PL3.

The seventh switch element T7 is connected between the third node n3 and the fourth node n4. The seventh switch element T7 is turned on in response to the gate-on voltage VGL of the fourth gate signal EM to connect the third node n3 to the fourth node n4. The seventh switch element T7 includes a first electrode connected to the third node n3, a gate electrode to which the fourth gate signal EM is applied, and a second electrode connected to the fourth node n4.

The eighth switch element T8 is connected between the fifth node n5 and the third power line PL3. The eighth switch element T8 is turned on in response to the gate-on voltage VGL of the second gate signal SCAN2 to connect the fifth node n5 to the third power line PL3 through which the reference voltage Vref is applied. The eighth switch element T8 includes a first electrode connected to the third power line PL3, a gate electrode to which the second gate signal SCAN2 is applied, and a second electrode connected to the fifth node n5.

The ninth switch element T9 is connected between the sixth node n6 and the third power line PL3. The ninth switch element T9 is turned on in response to the gate-on voltage VGL of the second gate signal SCAN2 to connect the sixth node n6 to the third power line PL3 through which the reference voltage Vref is applied. The ninth switch element T9 includes a first electrode connected to the third power line PL3, a gate electrode to which the second gate signal SCAN2 is applied, and a second electrode connected to the sixth node n6.

Referring to FIG. 3, a first lens LENS1 can be disposed on the first light-emitting element EL1. The first lens LENS1 can be a semi-cylindrical lens in order to limit a vertical viewing angle and widen a horizontal viewing angle. The first lens LENS1 is long in a horizontal direction (or the X-axis direction) of the display panel 100 and narrow in a vertical direction thereof. The first lens LENS1 can have a hemispherical cross section. The first lens condenses light traveling in the vertical direction among light of the first light-emitting element EL1 emitted in the first mode to narrow the vertical viewing angle and widen the horizontal viewing angle. By the first lens LENS1, the vertical viewing angle of the first light-emitting element EL1 is comparable to that of the second light-emitting element EL2, and the horizontal viewing angle thereof is larger than that of the second light-emitting element EL2. In FIG. 3, “R” indicates a red sub-pixel that emits red light, “G” indicates a green sub-pixel that emits green light, and “B” indicates a blue sub-pixel that emits blue light. The sub-pixels darkly expressed in FIG. 3 are non-driving sub-pixels that do not emit light.

Light emitted from a screen of a vehicle display disposed on a dashboard of a vehicle can travel to a front-facing camera disposed in front of an upper end of a room in the vehicle, and the screen of the vehicle display can be seen in an image captured by the front-facing camera. The first lens LENS1 limits the vertical viewing angle of the first light-emitting element EL1 that emits light in the first mode to prevent a ghost image of the screen of the vehicle display, which is captured by the front-facing camera.

A second lens LENS2 shown in FIG. 3 can be disposed on the second light-emitting element EL2. The second lens LENS2 can be a semi-spherical lens whose thickness is larger at the center and smaller toward an edge thereof. The second lens LENS2 can condense light of the second light-emitting element EL2 emitted in the second mode to narrow an up-down and left-right viewing angles of the second light-emitting element EL2.

The first and second lenses LENS1 and Lens2 can be implemented as transparent media or transparent insulating layer patterns disposed in the display panel 100, but the present disclosure is not limited thereto.

The first light-emitting element EL1 emits light at a first viewing angle by the first lens LENS1, and the second light-emitting element EL2 emits light at a second viewing angle smaller than the first viewing angle by the second lens LENS2.

This pixel circuit can be driven in a first mode in which the first light-emitting device EL1 with a narrow viewing angle emits light, or in a second mode in which the second light-emitting device EL2 in a wide viewing angle emits light.

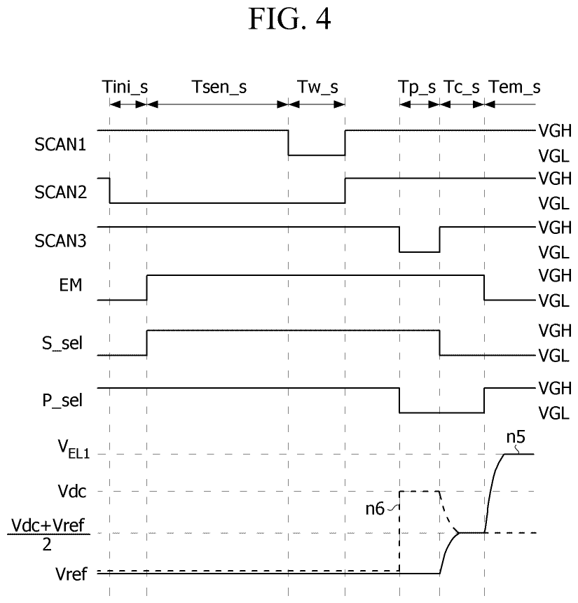

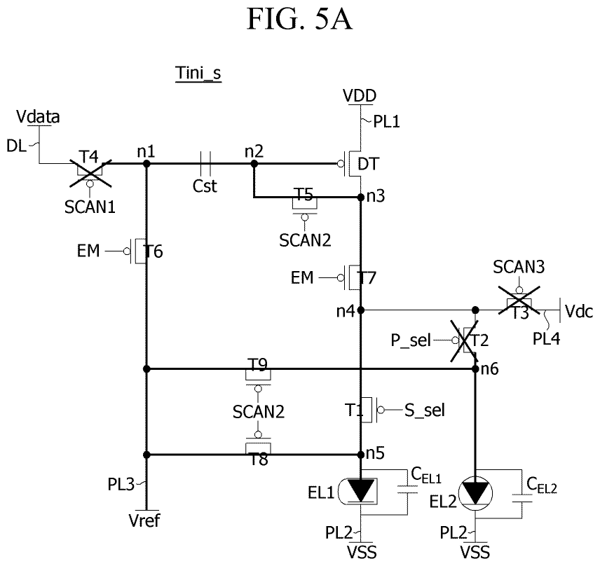

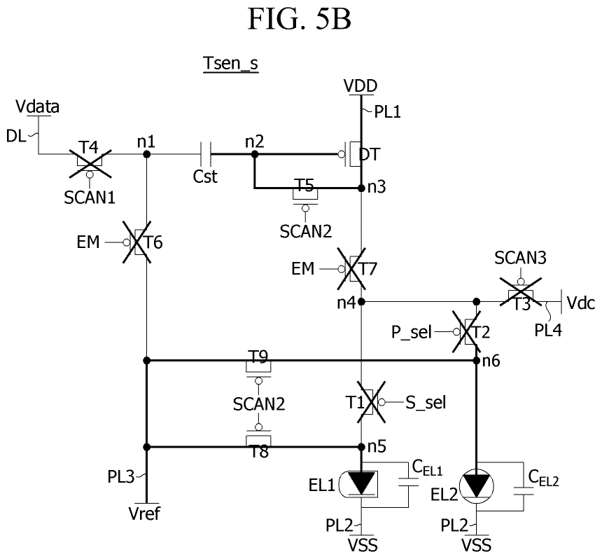

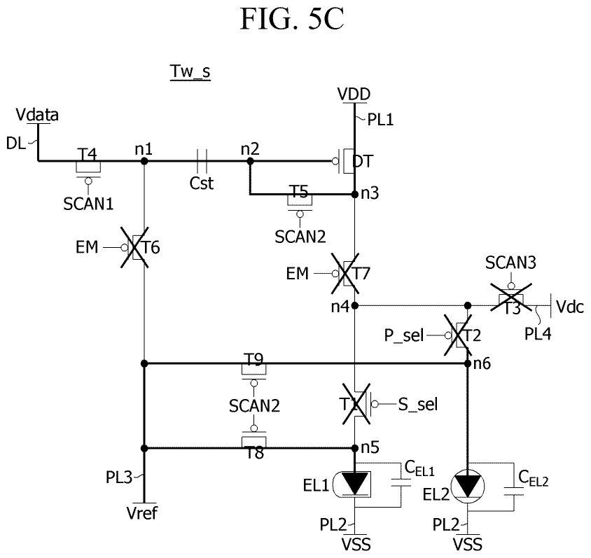

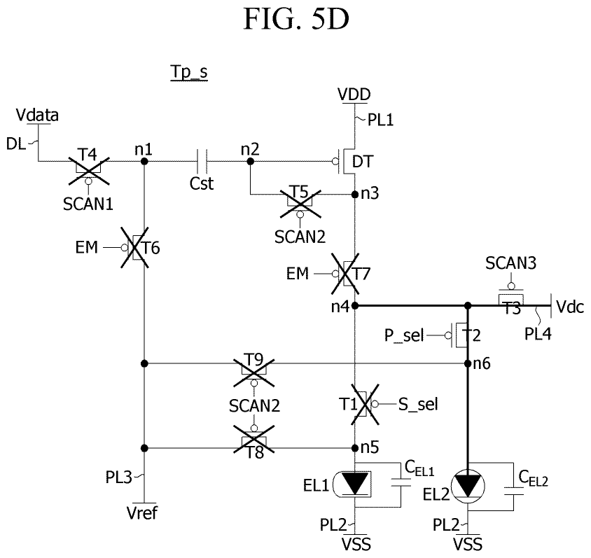

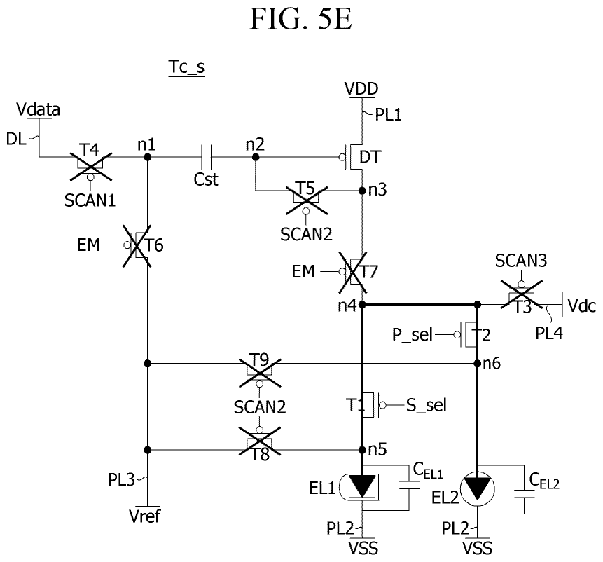

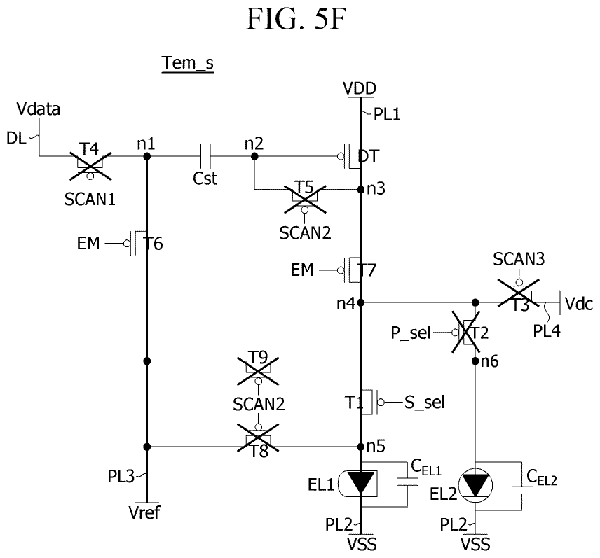

FIG. 4 is a diagram illustrating waveforms for driving the pixel circuit shown in FIG. 2 in a first mode. FIGS. 5A to 5F are diagrams illustrating an operation of a pixel circuit in a first mode driving.

Referring to FIG. 4, in the first mode, the pixel circuit is driven in the order of an initialization period Tini_s, a sensing period Tsen_s, a data write period Tw_s, a pre-charging period Tp_s, a charge share period Tc_s, and an emission period Tem_s.

Referring to FIG. 5A, during the initialization period Tini_s, the second to fourth switch elements T2 to T4 are turned off, while the first switch element T1 and the fifth to ninth switch elements T5 to T9 are turned on, so that the reference voltage Vref is applied to both ends of the capacitor Cst, i.e., the first node n1 and the second node n2, and to the anode electrodes of the first and second light emitting elements, i.e., the fifth node n5 and the sixth node n6, to initialize them.

Referring to FIG. 5B, during the sensing period Tsen_s, the first to fourth switch elements T1 to T4 and the sixth and seventh switch elements T6 and T7 are turned off, while the fifth, eighth, and ninth switch elements T5, T8, and T9 are turned on, so that the pixel driving voltage is applied to the second node n2 to sense the threshold voltage Vth of the driving element DT. As a result, the voltage at the second node n2 becomes VDD+Vth.

Referring to FIG. 5C, during the data write period Tw_s, the first to third switch elements T1 to T3 and the sixth and seventh switch elements T6 and T7 are turned off, while the fourth, fifth, eighth, and ninth switch elements T4, T5, T8, and T9 are turned on to apply the data voltage Vdata to the first node n1. As a result, the voltage at the first node n1 becomes Vdata, and the voltage at the second node n2 becomes VDD+Vth.

Referring to FIG. 5D, during the pre-charging period Tp_s, the first switch element T1 and the fourth to ninth switch elements T4 to T9 are turned off, while the second and third switch elements T2 and T3 are turned on to pre-charge the sixth node n6 with the compensation voltage Vdc. As a result, the voltage at the sixth node n6 becomes Vref+Vdc, and a second parasitic capacitor CEL2 is charged with a charge +Q.

In this case, the compensation voltage Vdc can be higher than the reference voltage Vref to precharge the sixth node n6, which has been initialized to the reference voltage Vref, and can satisfy:

$$Vref < Vdc < {V}_{EL 1} , {V}_{EL 2}$$

to prevent the light emitting elements from emitting light before the emission period. Here, V_{EL1} represents a voltage across both ends of the first light emitting element EL1, and V_{EL2} represents a voltage across both ends of the second light emitting element EL2.

Referring to FIG. 5E, during the charge share period Tc_s, the third to ninth switch elements T3 to T9 are turned off, while the first and second switch elements T1 and T2 are turned on to short the anode electrode of the first light emitting element, i.e., the fifth node n5, and the anode electrode of the second light emitting element, i.e., the sixth node n6, by connecting them to each other. As a result, the voltages at the fifth node n5 and the sixth node n6 are charge-shared, each becoming (Vref+Vdc)/2, and the second parasitic capacitor C_{EL2} is discharged with a charge +Q/2, while a first parasitic capacitor C_{EL1} is charged with an equal amount of charge +Q/2.

Referring to FIG. 5F, during the emission period Tem_s, the second to fifth switch elements T2 to T5 and the eighth and ninth switch elements T8 and T9 are turned off, while the first, sixth, and seventh switch elements T1, T6, and T7 are turned on, so that a current flows through the driving element DT, causing the first light emitting element EL1 to emit light.

In this case, since the voltage at the fifth node n5 is (Vref+Vdc)/2 rather than the reference voltage Vref, the time to rise to the threshold voltage of the first light emitting element can be reduced, thereby reducing the luminance deviation.

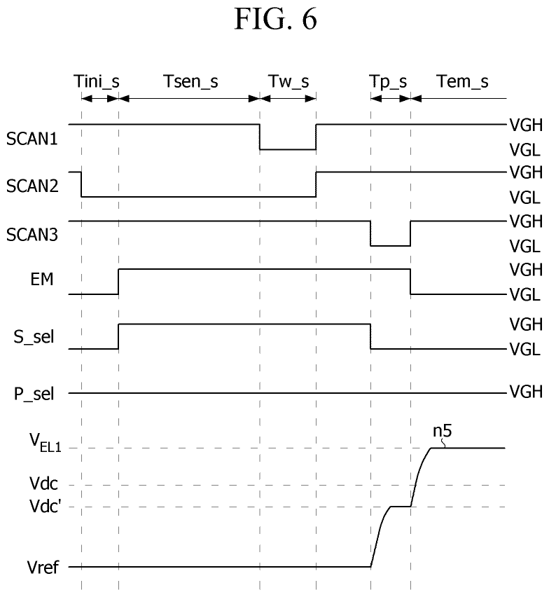

FIG. 6 is a diagram illustrating different waveforms for driving the pixel circuit shown in FIG. 2 in a first mode.

Referring to FIG. 6, in the first mode, the pixel circuit is driven in the order of the initialization period Tini_s, the sensing period Tsen_s, the data write period Tw_s, the pre-charging period Tp_s, and the emission period Tem_s.

Here, since the compensation voltage is directly applied to the anode electrode of the first light emitting element, unlike in FIG. 4, the charge share period may not be required and a voltage lower than the compensation voltage Vdc can be used.

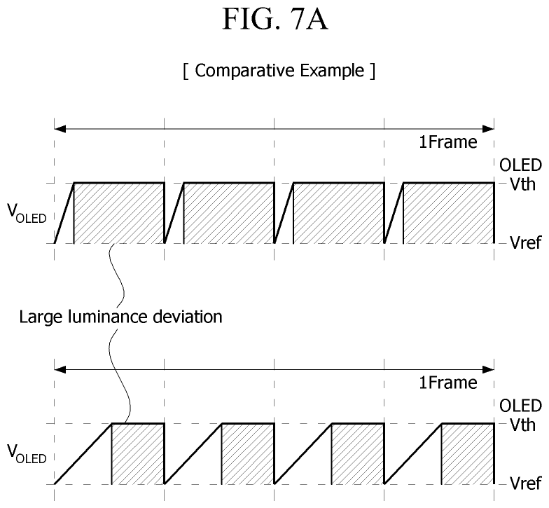

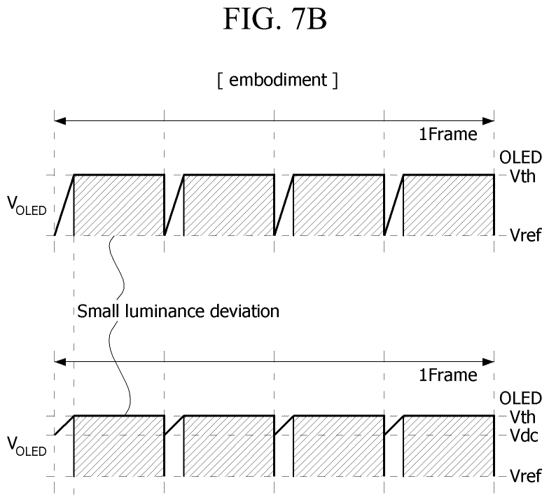

FIGS. 7A and 7B are diagrams comparing luminance deviations between a comparative example and an embodiment of the present disclosure.

Referring to FIG. 7A, the pixel circuit according to a comparative example is a circuit to which a separate compensation voltage is not applied, unlike the embodiment shown in FIG. 2. In this case, due to a deviation in the panel fabrication process, a difference in the capacitance of the parasitic capacitors formed in the light emitting elements occurs at each in-plane position. This results in a difference in charging time of the anode voltages of the light emitting elements in a low grayscale with a small amount of current, leading to a deviation in luminance uniformity in a low grayscale.

For example, when the capacitance of the parasitic capacitor is large, the charging time of the anode voltage of the light emitting element is short, so the luminance becomes relatively high, and when the capacitance of the parasitic capacitor is small, the charging time of the anode voltage of the light emitting element is long, so the luminance becomes relatively low.

Referring to FIG. 7B, the pixel circuit according to an embodiment is a circuit to which the compensation voltage shown in FIG. 2 is applied. In this case, even if a difference in the capacitance of the parasitic capacitors formed in the light emitting elements occurs at each in-plane position due to a deviation in the panel fabrication process, the deviation in luminance uniformity is compensated by precharging the anode voltage of the light emitting element with a separate compensation voltage higher than the reference voltage during the driving process, and driving the precharged voltage to be charge-shared between two adjacent light emitting elements to increase the initial anode voltage of the light emitting element.

For example, when the capacitance of the parasitic capacitor is small, the initial anode voltage of the light emitting element is increased, so the charging time is shortened, resulting in higher luminance. The luminance deviation is compensated through such charge sharing between the anode voltages of the light emitting elements.

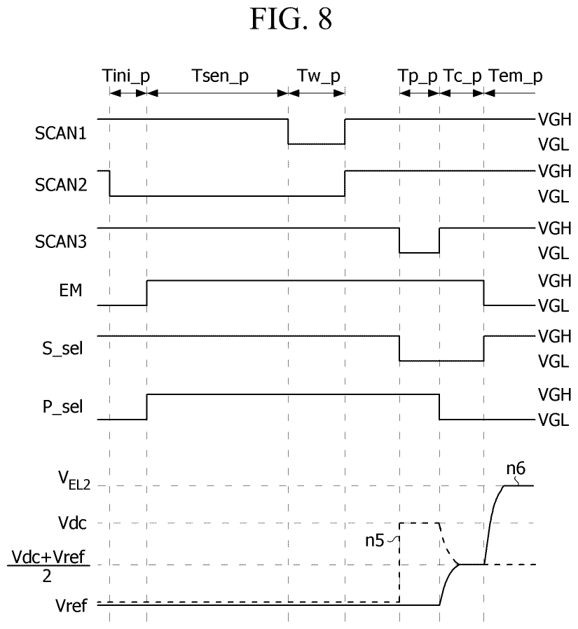

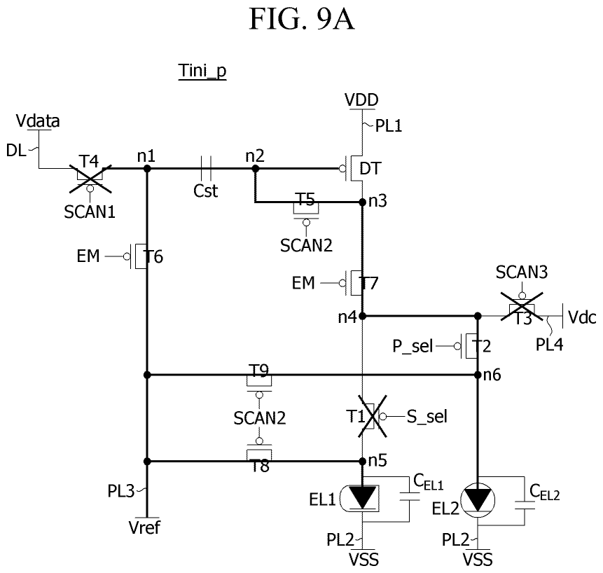

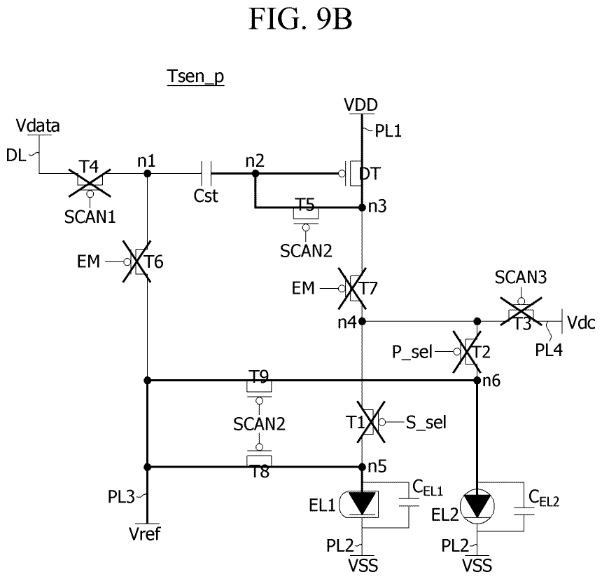

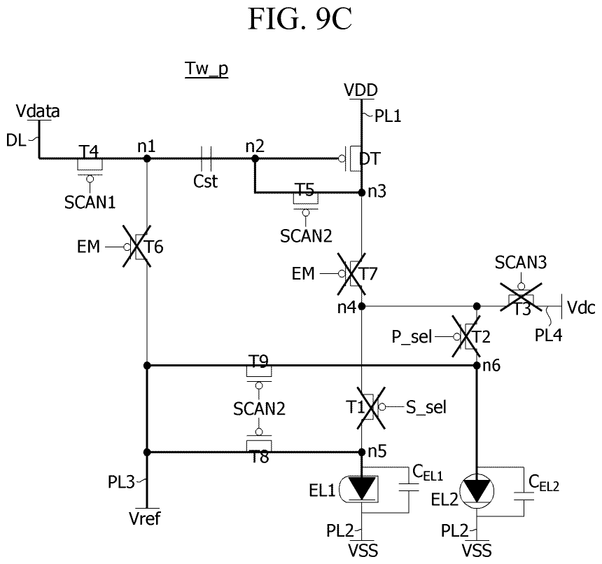

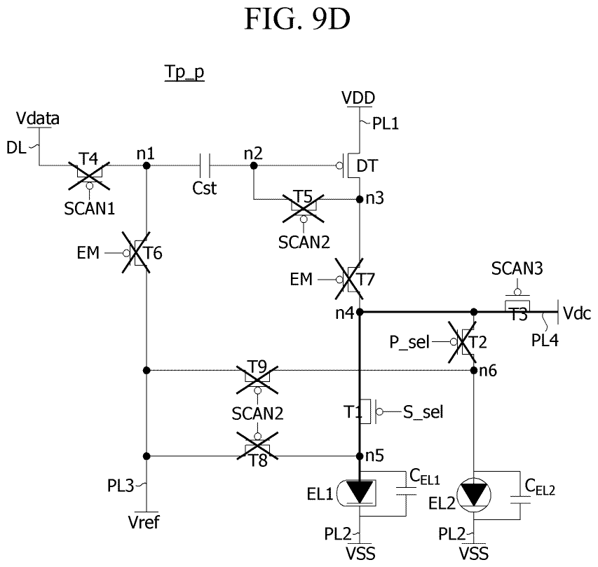

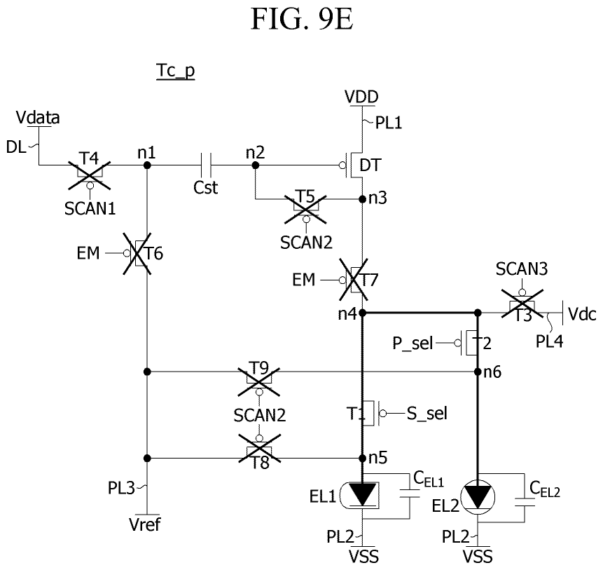

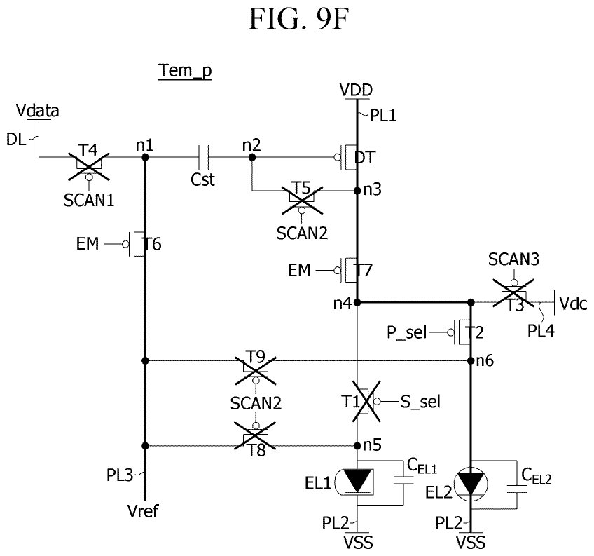

FIG. 8 is a diagram illustrating waveforms for driving the pixel circuit shown in FIG. 2 in a second mode. FIGS. 9A to 9F are diagrams illustrating an operation of a pixel circuit in a second mode driving.

Referring to FIG. 8, in the second mode, the pixel circuit is driven in the order of an initialization period Tini_p, a sensing period Tsen_p, a data write period Tw_p, a pre-charging period Tp_p, a charge share period Tc_p, and an emission period Tem_p.

Referring to FIG. 9A, during the initialization period Tini_p, the first, third, and fourth switch elements T1, T3, and T4 are turned off, while the second switch element T2 and the fifth to ninth switch elements T5 to T9 are turned on, so that the reference voltage Vref is applied to both ends of the capacitor Cst, i.e., the first node n1 and the second node n2, and to the anode electrodes of the first and second light emitting elements, i.e., the fifth node n5 and the sixth node n6, to initialize them.

Referring to FIG. 9B, during the sensing period Tsen p, the first to fourth switch elements T1 to T4 and the sixth and seventh switch elements T6 and T7 are turned off, while the fifth, eighth, and ninth switch elements T5, T8, and T9 are turned on, so that the pixel driving voltage is applied to the second node n2 to sense the threshold voltage Vth of the driving element DT. As a result, the voltage at the second node n2 becomes VDD+Vth.

Referring to FIG. 9C, during the data write period Tw_p, the first to third switch elements T1 to T3 and the sixth and seventh switch elements T6 and T7 are turned off, while the fourth, fifth, eighth, and ninth switch elements T4, T5, T8, and T9 are turned on to apply the data voltage Vdata to the first node n1. As a result, the voltage at the first node n1 becomes Vdata, and the voltage at the second node n2 becomes VDD+Vth.

Referring to FIG. 9D, during the pre-charging period Tp_p, the second switch element T2 and the fourth to ninth switch elements T4 to T9 are turned off, while the first and third switch elements T1 and T3 are turned on to pre-charge the fifth node n5 with the compensation voltage Vdc. As a result, the voltage at the fifth node n5 becomes Vref+Vdc, and the first parasitic capacitor C_{EL1} is charged with a charge +Q.

In this case, the compensation voltage Vdc can be higher than the reference voltage Vref to precharge the fifth node n5, which has been initialized to the reference voltage Vref, and can satisfy:

$$Vref < Vdc < {V}_{EL 1} , {V}_{EL 2}$$

to prevent the light emitting elements from emitting light before the emission period. Here, V_{EL1} represents a voltage across both ends of the first light emitting element EL1, and V_{EL2} represents a voltage across both ends of the second light emitting element EL2.

Referring to FIG. 9E, during the charge share period Tc_p, the third to ninth switch elements T3 to T9 are turned off, while the first and second switch elements T1 and T2 are turned on to short the anode electrode of the first light emitting element, i.e., the fifth node n5, and the anode electrode of the second light emitting element, i.e., the sixth node n6, by connecting them to each other. As a result, the voltages at the fifth node n5 and the sixth node n6 are charge-shared, each becoming (Vref+Vdc)/2, and the first parasitic capacitor C_{EL1} is discharged with a charge +Q/2, while the second parasitic capacitor C_{EL2} is charged with a charge +Q/2.

Referring to FIG. 9F, during the emission period Tem p, the first switch element T1, the third to fifth switch elements T3 to T5, and the eighth and ninth switch elements T8 and T9 are turned off, while the second, sixth, and seventh switch elements T2, T6, and T7 are turned on, so that a current flows through the driving element DT, causing the second light emitting element EL2 to emit light.

In this case, since the voltage at the sixth node n6 is (Vref+Vdc)/2 rather than the reference voltage Vref, the time to rise to the threshold voltage of the second light emitting element can be reduced, thereby reducing the luminance deviation.

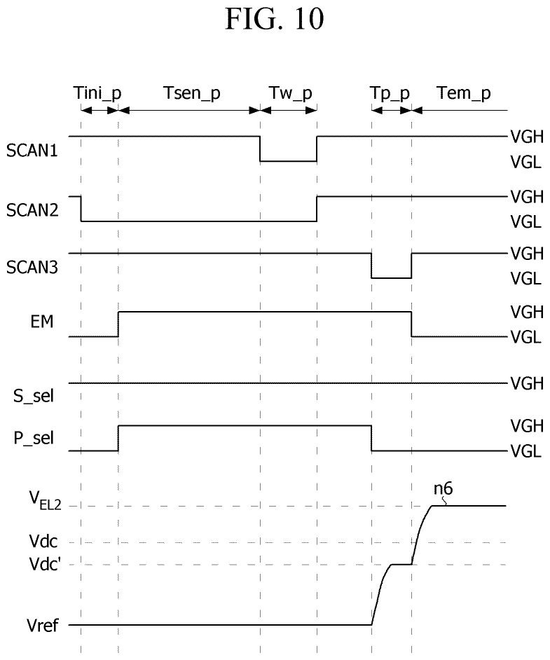

FIG. 10 is a diagram illustrating different waveforms for driving the pixel circuit shown in FIG. 2 in a second mode.

Referring to FIG. 10, in the second mode, the pixel circuit is driven in the order of the initialization period Tini_p, the sensing period Tsen_p, the data write period Tw_p, the pre-charging period Tp_p, and the emission period Tem_p.

Here, since the compensation voltage is directly applied to the anode electrode of the second light emitting element, unlike in FIG. 8, the charge share period may not be required and a voltage lower than the compensation voltage Vdc can be used.

The pixel circuit according to an embodiment of the present disclosure can allow the first light emitting element or the second light emitting element to selectively emit light, but is not limited thereto. For example, in the pixel circuit according to an embodiment, both the first light emitting element and the second light emitting element can emit light. When both the first and second light emitting elements emit light, it is possible to reproduce a high dynamic range (HDR) image with high luminance and high contrast ratio.

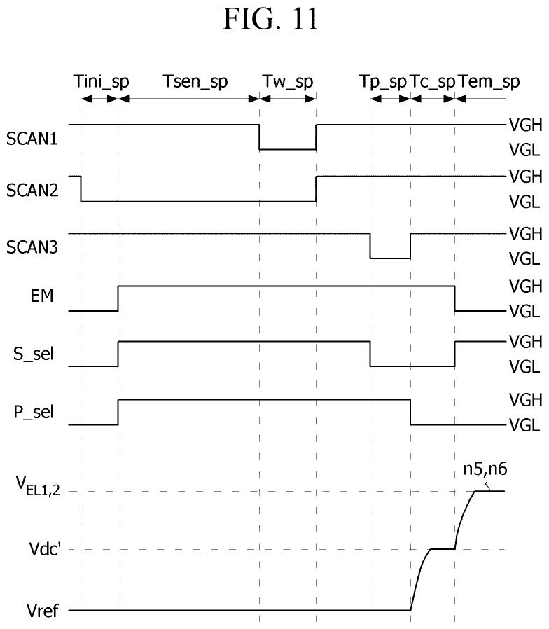

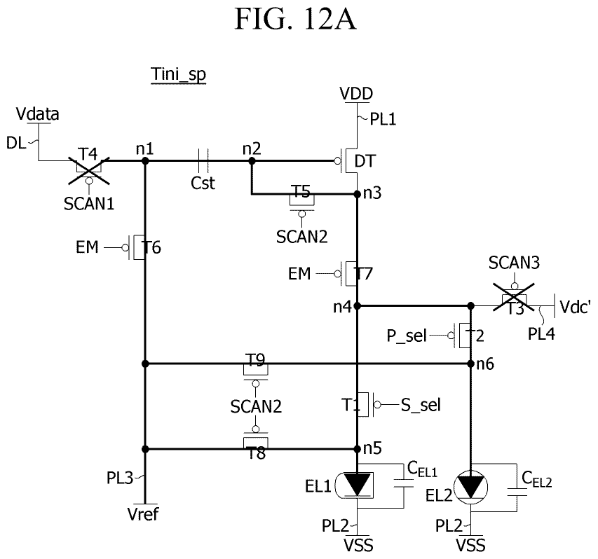

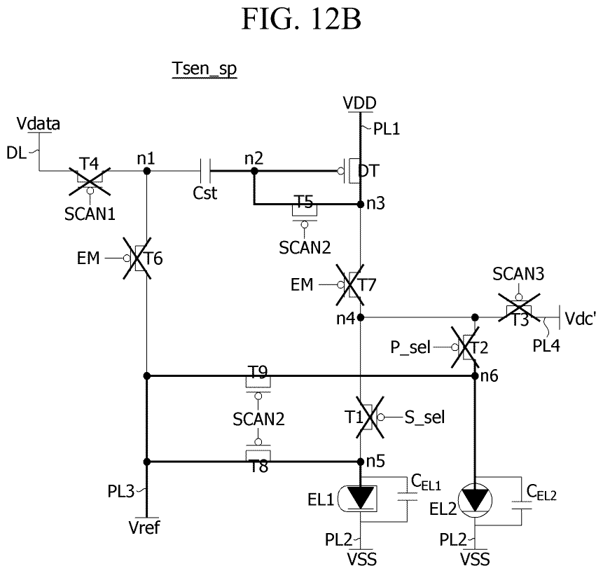

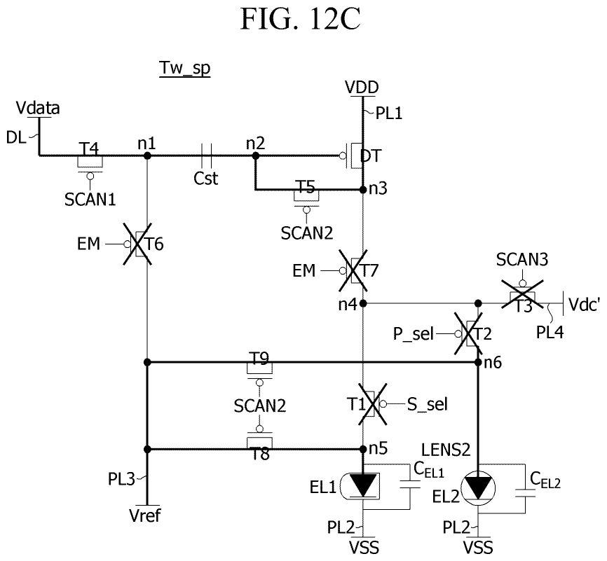

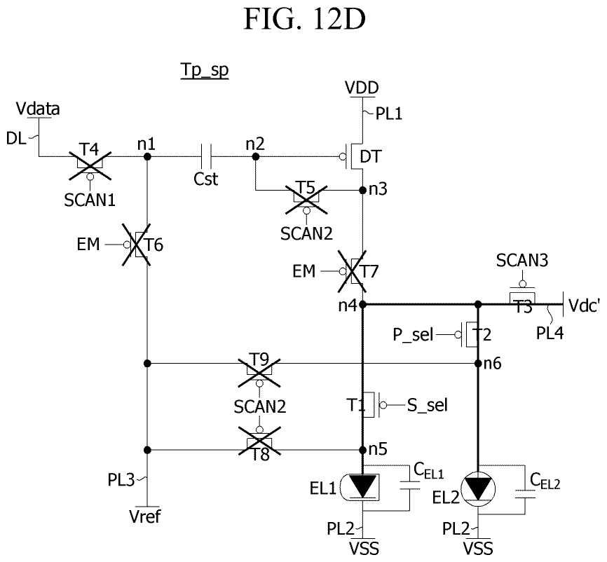

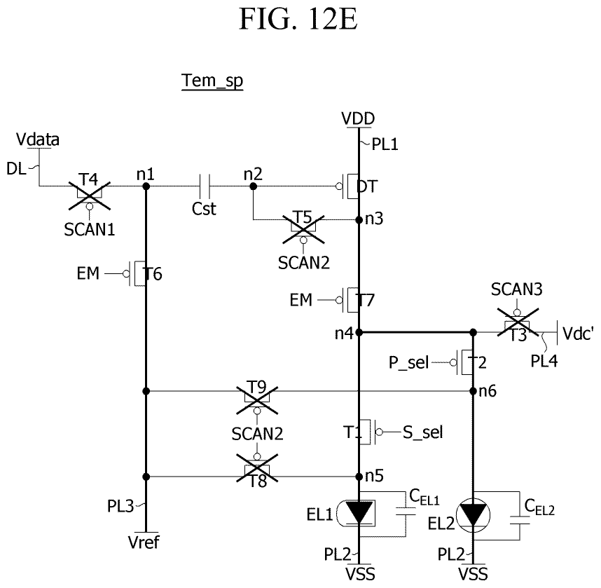

FIG. 11 is a diagram illustrating waveforms for simultaneously driving the pixel circuit shown in FIG. 2 in first and second modes. FIGS. 12A to 12E are diagrams illustrating an operation of the pixel circuit by the waveforms of FIG. 11.

Referring to FIG. 11, in simultaneous operation of the first and second modes, the pixel circuit is driven in the order of an initialization period Tini_sp, a sensing period Tsen_sp, a data write period Tw_sp, a pre-charging period Tp_sp, and an emission period Tem_sp.

Referring to FIG. 12A, during the initialization period Tini_sp, the third and fourth switch elements T3 and T4 are turned off, while the first and second switch elements T1 and T2 and the fifth to ninth switch elements T5 to T9 are turned on, so that the reference voltage Vref is applied to both ends of the capacitor Cst, i.e., the first node n1 and the second node n2, and to the anode electrodes of the first and second light emitting elements, i.e., the fifth node n5 and the sixth node n6, to initialize them.

Referring to FIG. 12B, during the sensing period Tsen_sp, the first to fourth switch elements T1 to T4 and the sixth and seventh switch elements T6 and T7 are turned off, while the fifth, eighth, and ninth switch elements T5, T8, and T9 are turned on, so that the pixel driving voltage is applied to the second node n2 to sense the threshold voltage Vth of the driving element DT. As a result, the voltage at the second node n2 becomes VDD+Vth.

Referring to FIG. 12C, during the data write period Tw_sp, the first to third switch elements T1 to T3 and the sixth and seventh switch elements T6 and T7 are turned off, while the fourth, fifth, eighth, and ninth switch elements T4, T5, T8, and T9 are turned on to apply the data voltage Vdata to the first node n1. As a result, the voltage at the first node n1 becomes Vdata, and the voltage at the second node n2 becomes VDD+Vth.

Referring to FIG. 12D, during the pre-charging period Tp_sp, the fourth to ninth switch elements T4 to T9 are turned off, while the first to third switch elements T1 to T3 are turned on to apply a compensation voltage Vdc′ to the fifth and sixth nodes n5 and n6. As a result, the voltages at the fifth node n5 and the sixth node n6 both become Vref+Vdc′, and the first parasitic capacitor C_{EL1} and the second parasitic capacitor C_{EL2} are each charged with a charge +Q.

In this case, the compensation voltage Vdc′ can be a voltage lower than that in the first mode or the second mode operation, satisfying Vref<Vdc′<V_{EL1}, V_{EL2}. Here, V_{EL1} represents a voltage across both ends of the first light emitting element EL1, and V_{EL2} represents a voltage across both ends of the second light emitting element EL2.

In simultaneous operation of the first mode and the second mode, a separate charge share period is not required since the compensation voltage Vdc′ is simultaneously applied to the fifth node n5 and the sixth node n6.

Referring to FIG. 12E, in the emission period Tem_sp, the third to fifth switch elements T3 to T5 and the eighth and ninth switch elements T8 and T9 are turned off, while the first, second, sixth, and seventh switch elements T1, T2, T6, and T7 are turned on, so that a current flows through the driving element DT, causing both the first light emitting element EL1 and the second light emitting element EL2 to emit light.

In this case, since the voltages at the fifth and sixth nodes are the compensation voltage Vdc′ rather than the reference voltage Vref, the time to rise to the threshold voltage of the light emitting element can be reduced, thereby reducing the luminance deviation.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A pixel circuit comprising:
a first light emitting element;
a second light emitting element;
a driving element configured to drive the first and second light emitting elements;
a compensation circuit connected to the driving element;
a first switch element connected between the driving element and the first light emitting element and driven by a first mode selection signal;
a second switch element connected between the driving element and the second light emitting element and driven by a second mode selection signal; and
a third switch element configured to apply a predetermined compensation voltage to at least one of anode electrodes of the first light emitting element and the second light emitting element.

2. The pixel circuit of claim 1, wherein the pixel circuit is driven in the order of an initialization period, a sensing period, a data write period, a pre-charging period, and an emission period,
wherein during the initialization period, a reference voltage is applied to the anode electrodes of the first light emitting element and the second light emitting element to initialize the first and second light emitting elements, and
during the pre-charging period, the compensation voltage is applied to one of the anode electrodes of the first light emitting element and the second light emitting element which have been initialized to the reference voltage.

3. The pixel circuit of claim 2, wherein the compensation voltage is set to be greater than the reference voltage and is set to be less than a voltage across both ends of each of the first light emitting element and the second light emitting element.

4. The pixel circuit of claim 2, wherein the pixel circuit is driven in a charge share period after the pre-charging period, and
during the charge share period, the anode electrode of the first light emitting element and the anode electrode of the second light emitting element are connected to each other to share the applied compensation voltage.

5. The pixel circuit of claim 4, wherein the compensation circuit includes:
a capacitor connected between a first node and a second node to which a gate electrode of the driving element is connected;
a fourth switch element including a first electrode connected to a data line, a second electrode connected to the first node, and a gate electrode to which a first gate signal is applied;
a fifth switch element including a first electrode connected to the second node, a second electrode connected to a third node to which a source electrode of the driving element is connected, and a gate electrode to which a second gate signal is applied;
a sixth switch element including a first electrode connected to the first node, a second electrode connected to a reference voltage line, and a gate electrode to which a fourth gate signal is applied;
a seventh switch element including a first electrode connected to the third node, a second electrode connected to a fourth node, and a gate electrode to which the fourth gate signal is applied;
an eighth switch element including a first electrode connected to the reference voltage line, a second electrode connected to a fifth node to which the anode electrode of the first light emitting element is connected, a gate electrode to which the second gate signal is applied; and
a ninth switch element including a first electrode connected to the reference voltage line, a second electrode connected to a sixth node connected to which the anode electrode of the second light emitting element is connected, and a gate electrode to which the second gate signal is applied.

6. The pixel circuit of claim 5, wherein:
the first switch element includes a first electrode connected to the fourth node, a second electrode connected to the fifth node, and a gate electrode to which the first mode selection signal is applied,
the second switch element includes a first electrode connected to the fourth node, a second electrode connected to the sixth node, and a gate electrode to which the second mode selection signal is applied, and
the third switch element includes a first electrode connected to the fourth node, a second electrode connected to a power line through which the compensation voltage is applied, and a gate electrode to which a third gate signal is applied.

7. The pixel circuit of claim 6, wherein during the pre-charging period, at least one of the first switch element and the second switch element, and the third switch element are turned on, while all the other switch elements are turned off.

8. The pixel circuit of claim 7, wherein during the charge share period, the first switch element and the second switch element are turned on, while all the other switch elements are turned off.

9. A display device comprising:
a pixel array in which a plurality of data lines, a plurality of gate lines, and a plurality of pixel circuits are disposed;
a data driver configured to output a data voltage to the plurality of data lines; and
a gate driver configured to output a gate signal to the plurality of gate lines,
wherein each of the plurality of pixel circuits includes:
a first light emitting element;
a second light emitting element;
a driving element configured to drive the first and second light emitting elements;
a compensation circuit connected to the driving element;
a first switch element connected between the driving element and the first light emitting element and driven by a first mode selection signal;
a second switch element connected between the driving element and the second light emitting element and driven by a second mode selection signal; and
a third switch element configured to apply a predetermined compensation voltage to at least one of anode electrodes of the first light emitting element and the second light emitting element.

10. The display device of claim 9, wherein the pixel circuit is driven in the order of an initialization period, a sensing period, a data write period, a pre-charging period, and an emission period,
wherein during the initialization period, a reference voltage is applied to the anode electrodes of the first light emitting element and the second light emitting element to initialize the first and second light emitting elements, and
during the pre-charging period, the compensation voltage is applied to one of the anode electrodes of the first light emitting element and the second light emitting element which have been initialized to the reference voltage.

11. The display device of claim 10, wherein the pixel circuit is driven in a charge share period after the pre-charging period, and
during the charge share period, the anode electrode of the first light emitting element and the anode electrode of the second light emitting element are connected to each other to share the applied compensation voltage.

12. The display device of claim 11, wherein the compensation circuit includes:
a capacitor connected between a first node and a second node to which a gate electrode of the driving element is connected;
a fourth switch element including a first electrode connected to a data line, a second electrode connected to the first node, and a gate electrode to which a first gate signal is applied;
a fifth switch element including a first electrode connected to the second node, a second electrode connected to a third node to which a source electrode of the driving element is connected, and a gate electrode to which a second gate signal is applied;
a sixth switch element including a first electrode connected to the first node, a second electrode connected to a reference voltage line, and a gate electrode to which a fourth gate signal is applied;
a seventh switch element including a first electrode connected to the third node, a second electrode connected to a fourth node, and a gate electrode to which the fourth gate signal is applied;
an eighth switch element including a first electrode connected to the reference voltage line, a second electrode connected to a fifth node to which the anode electrode of the first light emitting element is connected, a gate electrode to which the second gate signal is applied; and
a ninth switch element including a first electrode connected to the reference voltage line, a second electrode connected to a sixth node connected to which the anode electrode of the second light emitting element is connected, and a gate electrode to which the second gate signal is applied.

13. The display device of claim 12, wherein:
the first switch element includes a first electrode connected to the fourth node, a second electrode connected to the fifth node, and a gate electrode to which the first mode selection signal is applied,
the second switch element includes a first electrode connected to the fourth node, a second electrode connected to the sixth node, and a gate electrode to which the second mode selection signal is applied, and
the third switch element includes a first electrode connected to the fourth node, a second electrode connected to a power line through which the compensation voltage is applied, and a gate electrode to which a third gate signal is applied.

14. The display device of claim 9, further comprising a timing controller,
wherein the first and second mode selection signals are received from the timing controller.
